(19) United States
(12) Patent Application Publication
(10) Pub. No.: US 2021/0303574 A1
(43) Pub. Date: Sep. 30, 2021

(54) MATRIX-RELATED OPERATIONS IN RELATIONAL DATABASES SYSTEMS INCLUDING MASSIVELY PARALLEL PROCESSING SYSTEMS

(71) Applicant: Paul Geoffrey Brown, Concord, MA (US)

(72) Inventor: Paul Geoffrey Brown, Concord, MA (US)

(21) Appl. No.: 17/139,289

(22) Filed: Dec. 31, 2020

Related U.S. Application Data
(60) Provisional application No. 63/003,069, filed on Mar. 31, 2020.

(51) Int. Cl. G06F 16/2453; G06F 17/16

(52) U.S. Cl. CPC G06F 16/24544; G06F 17/16

(57) ABSTRACT

Improved techniques for performing Matrix-Related operations (e.g., Matrix Multiplication, Matrix Transpose) in Relational Database systems are disclosed. Techniques provide Matrix Data Sets for performing Matrix-Related operations in Relational Databases more efficiently than conventional techniques. By way of example, Matrix Data can be partitioned such that data each partition can be processed directly in a cache memory of a processor thereby reducing the need for copying data as it is conventionally done in Relational Databases. In addition, database queries involving Matrix-Related operations can be optimized for a Relational Database by providing Matrix Operations that can be directly used as declarative statements in a Database Query language (e.g., SQL). Furthermore, database query optimizers of a Relational Database can be further enhanced by allowing them to consider Matrix Algebra, as well as other opportunities in processing Matrix-related operation, possibly in connection of one or more the facets of the improved techniques.

### CROSS-REFERENCE TO RELATED PATENT APPLICATIONS

This Patent Application takes priority from the U.S. Provisional Patent Application No. 63/003,069, entitled: “EXTENDING SQL SYNTAX TO SUPPORT LINEAR ALGEBRA OPERATIONS” by Paul Geoffrey Brown, filed on Mar. 31, 2020.

### BACKGROUND

In the context of computing environments and systems, data can encompass virtually all forms of information. Data can be stored in a computer readable medium (e.g., memory, hard disk). Data, and in particular, one or more instances of data can also be referred to as data object(s). As it is generally known in the art, a data object can for example, be an actual instance of data, a class, type, or form data, and so on.

The term database can refer to a collection of data and/or data structures typically stored in a digital form. Data can be stored in a database for various reasons and to serve various entities or “users.” Generally, data stored in the database can be used by the database users. A user of a database can, for example, be a person, a database administrator, a computer application designed to interact with a database, etc. A very simple database or database system can, for example, be provided on a Personal Computer (PC) by storing data on a Hard Disk (e.g., contact information) and executing a computer program that allows access to the data. The executable computer program can be referred to as a database program or a database management program. The executable computer program can, for example, retrieve and display data (e.g., a list of names with their phone numbers) based on a request submitted by a person (e.g., show me the phone numbers of all my friends in San Diego).

Generally, database systems are much more complex than the example noted above. In addition, databases have been evolved over the years and some databases that are for various business and organizations (e.g., banks, retail stores, governmental agencies, universities) in use today can be very complex and support several users simultaneously by providing very complex queries (e.g., give me the name of all customers under the age of thirty five (35) in Ohio that have bought all items in a list of items in the past month in Ohio and also have bought ticket for a baseball game in San Diego and purchased a baseball in the past 10 years).

Typically, a Database Manager (DM) or a Database Management System (DBMS) is provided for relatively large and/or complex databases. As known in the art, a DBMS can effectively manage the database or data stored in a database, and serve as an interface for the users of the database. A DBMS can be provided as an executable computer program (or software) product as is also known in the art.

It should also be noted that a database can be organized in accordance with a Data Model. Notable Data Models include a Relational Model, an Entity-relationship model, and an Object Model. The design and maintenance of a complex database can require highly specialized knowledge and skills by database application programmers, DBMS developers/programmers, database administrators (DBAs), etc. To assist in design and maintenance of a complex database, various tools can be provided, either as part of the DBMS or as free-standing (stand-alone) software products. These tools can include specialized Database languages (e.g., Data Description Languages, Data Manipulation Languages, Query Languages). Database languages can be specific to one data model or to one DBMS type. One widely supported language is Structured Query Language (SQL) developed, by in large, for Relational Model and can combine the roles of Data Description Language, Data Manipulation language, and a Query Language.

Today, databases have become prevalent in virtually all aspects of business and personal life. Moreover, database use is likely to continue to grow even more rapidly and widely across all aspects of commerce. Generally, databases and DBMS that manage them can be very large and extremely complex partly in order to support an ever increasing need to store data and analyze data. Typically, larger databases are used by larger organizations. Larger databases are supported by a relatively large amount of capacity, including computing capacity (e.g., processor and memory) to allow them to perform many tasks and/or complex tasks effectively at the same time (or in parallel). On the other hand, smaller databases systems are also available today and can be used by smaller organizations. In contrast to larger databases, smaller databases can operate with less capacity.

A popular type of database is the Relational Database Management System (RDBMS), which includes relational tables, also referred to as relations, made up of rows and columns (also referred to as tuples and attributes). Each row represents an occurrence of an entity defined by a table, with an entity being a person, place, thing, or other object about which the table contains information.

One important aspect of database systems is various database operations that they support and optimization of the database queries of the data stored in the database, as it is generally appreciated by those skilled in the art. One such database operation is generally known as a database Join operation (or “Join” as also may be referred to herein). For example, in a SQL environment, a SQL Join statement can be used to combine data or rows from two or more tables based on a common field between them. Different types of Joins include, INNER JOIN, LEFT JOIN, RIGHT JOIN and FULL JOIN. Simply put a Join operation can be used to effectively combine the information provided in database (e.g., as database tables) to address database quarriers. For example, in a database where a first database table provides information about students and their age, a second database table that provides information about the students and their favorite subjects and a third database that provides information about the students and their respective Grade Point Averages (GPA's), join operations can be suggestively applied to the tables to effectively join their information to address various database queries, including, for example, finding all the students that are age 19 with a GPA of 3.5 or higher that have “math” as their favorite subject, and so on.

A more recent development in database systems is the use of multi-processing computing or parallel computing system, especially Massively Parallel Processing (MPP) database systems that use a relatively large number of processing units to process data in parallel.

Another more recent development is the development of modern analytics (or data analytics) methods including, for example, statistical analytics, machine learning methods, discrete mathematics (e.g., graph analytics, deep learning). These modern analytics can be quite complex. As such, MPP database systems, among other things, are relatively much better suited for running (or executing modern analytics (or data analytics) methods.

In view of the ever-increasing need for Relational Database systems to process more and more data for various applications in many different computing environments and systems, improved techniques for performing more modern applications (e.g., modern analytics) in Relational Database, especially in Massively Parallel Processing (MPP) database systems, would be very useful.

### SUMMARY

Broadly speaking, the invention relates to computing environments and systems. More particularly, the invention relates to improved techniques for performing Matrix-Related operations (e.g., Matrix Multiplication, Matrix Transpose) in Relational Database systems. The improved techniques are especially suited for Massively Parallel Processing (MPP) database systems where data can be disturbed between Multiple processors (or Multiple processing nodes) where data can be manipulated (e.g., by performing calculations) in parallel.

In accordance with one aspect of the improved techniques, Matrix Data Sets can be used to perform Matrix-Related operations in Relational Databases more efficiently than conventional techniques. A Matrix Data Set can, for example, be provided by partitioning of data of a matrix (matrix data) such that each partition (or member) of the Matrix Data Set is a disjoint subset of the matrix data being involved in a Matrix-Related operation (e.g., data of a matrix being involved in a matrix multiply operation). The Matrix-Related operation can, for example, be part as an expression in a database query of the Relational Database (e.g., a SQL database query). Generally, the matrix data can be partitioned at least based on or more physical properties of the matrix data and/or processor(s) to obtain a corresponding Matrix Data Set as a disjoint subset of the matrix data. By way of example, Matrix Data can be partitioned such that data in each member (or partition) of the resulting Matrix Data Set can be processed directly in a cache memory of a processor, thereby reducing the need for copying data as it is conventionally done in Relational Databases. As a result, performance of Relational Databases can be improved.

In accordance with another aspect, database queries involving Matrix-Related operations can be optimized for a Relational Database by providing Matrix Operations that can be directly used as declarative statements in a Database Query language (e.g., SQL).

In accordance yet another aspect, furthermore, database query optimizers of a Relational Database can be further enhanced by allowing them to consider Matrix Algebra, as well as other opportunities in processing Matrix-related operation, possibly in connection of one or more the aspect of the improved techniques.

Still other aspects, embodiment and advantages will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, wherein like reference numerals designate like structural elements, and in which:

FIGS. 1A-1B depict Matrix Data.

FIG. 1C depicts processing of a Matrix Data.

FIG. 2 depicts a Database Matrix Operations Optimizer (DBMOO) in a database computing environment in accordance with one embodiment.

FIG. 3 depicts a method of performing matrix-related operations associated with a relational database in accordance with one embodiment.

FIG. 4 depicts a method for optimizing a database query of a Relational Database in accordance with one embodiment.

FIGS. 5-6 depicts tables that can be used in connection with an innovative in accordance with one or more embodiments.

FIG. 7 depicts a table that lists a number of Basic Relational operators in accordance with one embodiment.

FIG. 8 illustrates what a sequence of these operators corresponding to a fairly simple query might look like in accordance with one embodiment.

FIG. 9 depicts complexity of computations of Matrix Multiply operations.

FIG. 10 depicts a row filter can be pushed through the Matrix Multiply to limit the size of the computation required in accordance with one embodiment.

FIG. 11 depicts combining blocks to compute the result in accordance with one embodiment.

FIGS. 12A-B depict partitioning matrix data into blocks result in accordance with one embodiment.

### DETAILED DESCRIPTION

As noted in the background section, in view of the ever-increasing need for Relational Database systems to process more and more data for various applications in many different computing environments and systems, improved techniques for performing more modern applications (e.g., modern data analytics) in Relational Databases, especially in Massively Parallel Processing (MPP) database systems, would be very useful. However, more modern applications rely on highly complex techniques requiring relatively large amounts of calculations and/or data processing (e.g., Machine Learning, Deep Learning). However, conventional Relational Databases are not well suited for performing some operations at the levels desired for more modern applications. As a result, providing more modern applications on Relational Databases has been very challenging.

One shortcoming of conventional Relational Databases is their inability to perform Matrix-Related Operations (e.g., Matrix Multiply, Matrix Transpose) at level desired to meet the requirements of more modern applications, for example, Data Analytics supported by Machine Learning and/or Deep Learning.

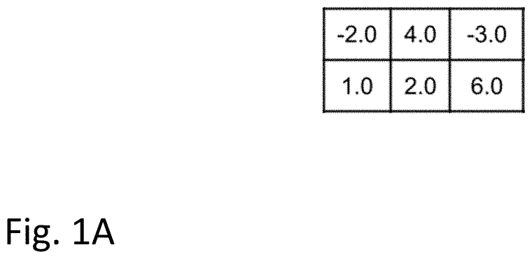

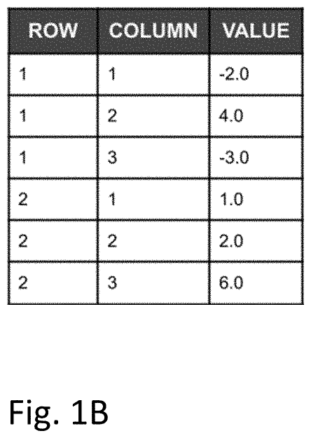

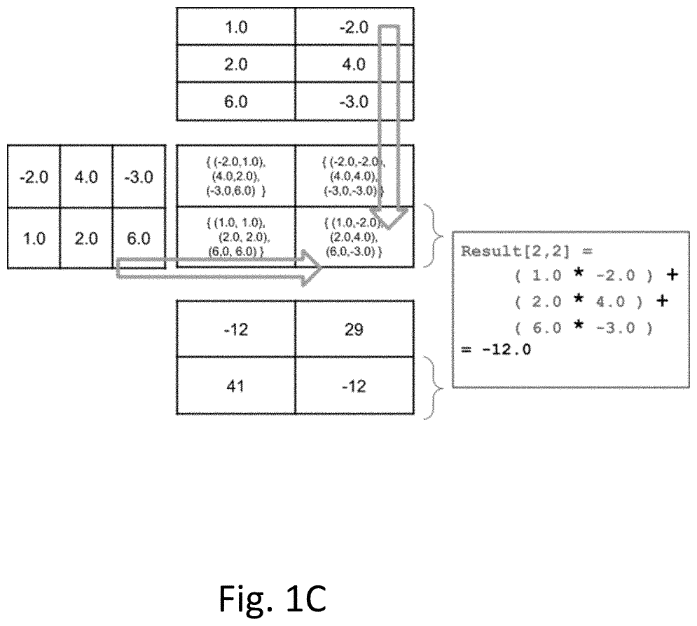

To elaborate, a Matrix (plural “Matrices”) can be represented in a rectangular arrangement of values, for example, as real numbers (show in the examples in FIG. 1A and describe below), but generally, as complex numbers, Booleans, or even other Matrices, etc. As shown in FIG. 1A, the values can be arranged into “rows” and “columns.”

In a mathematical Matrix, rows and columns are referred to by using indexing values. It is conventional to define an individual matrix in terms of how many index values appear in its rows and columns. Thus, the matrix shown in FIG. 1A might be represented as “A_{n,m}” where n is the number of rows (2) and m is the number of columns (3). When addressing individual cells within a matrix we use the cell's row and column index values, which uniquely identify a cell and its value. Thus A_{2,2}=2.0. We say the number of rows and columns in a matrix defines its shape.

A Matrix can correspond to a relation, for example, in the sense of a Relational Model that underpins a SQL DBMS. A Relation (e.g., a SQL TABLE) can include and/or be defined with a key (e.g., a set of fields/columns whose per-tuple/record values are unique within the relation/table) and optionally some fields/columns values that are not part of the key. As a pair of row-and-column values uniquely identify a cell (and its value) in a matrix, it follows that the row and column combination can be handled as if they were a key in a relation/table, with the cells' values being the other fields/columns. In a table form, the matrix shown in FIG. 1A would look like a table shown in FIG. 1B.

A Matrix multiplication can combine two mutually compatible matrices as input and produces a single matrix as output. The number of rows and columns in the output matrix can be determined by the number of rows in the first input matrix and the number of columns in the second, respectively. To be compatible for multiplication, the number of columns in the first matrix must equal the number of rows in the second.

The following notation says that we are multiplying an array A, which has n “rows” and m “columns” by another array B which has m “rows” and p “columns” to produce an output matrix C with n “rows” and p “columns”: A_{n,m}×B_{m,p}=>C_{n,p}.

Logically (this is not necessarily how the calculation is typically performed) it may be useful to think of matrix multiplication as having two phases. In the first phase, the values from the input matrices are paired up and each pair is sent to its appropriate cell in the output matrix in a process we refer to as partitioning. Then, in phase two, within each cell, the values in that cell's pairs are subjected to some basic aggregation operations, the definition of which constitutes what's known as a semi-ring.

FIG. 1C depicts the process of a matrix. Referring to FIG. 1C, in Phase One, data values from the rows and columns of the two input A_{2,3} and B_{3,2} matrices are paired and partitioned into segments of the output C_{2,2} matrix. Then, in Phase Two, the data in each output cell is combined and aggregated to produce the final per-output-cell values as shown.

If the input matrices to a multiply operation are organized as shown in FIG. 1C, it would be relatively straightforward to write a database query as a SQL query that computes a matrix multiply as:

SELECT A.R AS R,

B.C AS C,

```
  SUM ( A.V * B.V ) AS V
  FROM A JOIN B ON ( A.C = B.R )
  GROUP BY A.R, B.C;
```

Internally, a SQL DBMS can process the SQL query noted above in a manner very similar to the two-phase approach noted above. First, the data is organized into pairs, and each pair is routed to its output segment (or group). Then each pair is processed with the eventual output state of the segment being the result of the algebra applied to the pairs.

At this point, it's worth pointing out the computational inefficiency of this “copy input data to create pairs, bin the pairs, calculate per-bin aggregate” approach. The computational cost of matrix multiply is O(N\hat{ }2), where N is the number of Floating-Point values in the two inputs. Each value in A must be combined with every value in B. The algorithm described above means creating O(N\hat{ }2) pairs of values, and then performing O(N\hat{ }2) calculations, once for each pair. As such, SQL DBMSs are forced to adopt this pairing, partitioning and aggregating approach as a consequence of their reliance on Set Theoretic/Relational operators—specifically JOIN and PARTITION.

It should be noted that Pairing, partitioning and aggregating can vastly increase the cost of the matrix multiply operations relative to how it is done on non-DBMS platforms. However, it will be appreciated that in accordance with one aspect of the improved techniques disclosed below, a better practice can be adapted by bringing blocks of values from A and B into the CPU cache and computing the corresponding block of C results directly, reducing the need for copying the data.

In accordance with another aspect, database queries involving Matrix-Related operations can be optimized for a Relational Database by providing Matrix Operations that can be directly used as declarative statements in a Database Query language (e.g., SQL).

In accordance yet another aspect, furthermore, database query optimizers of a Relational Database can be further enhanced by allowing them to consider Matrix Algebra, as well as other opportunities in processing Matrix-related operation, possibly in connection of one or more the aspect of the improved techniques.

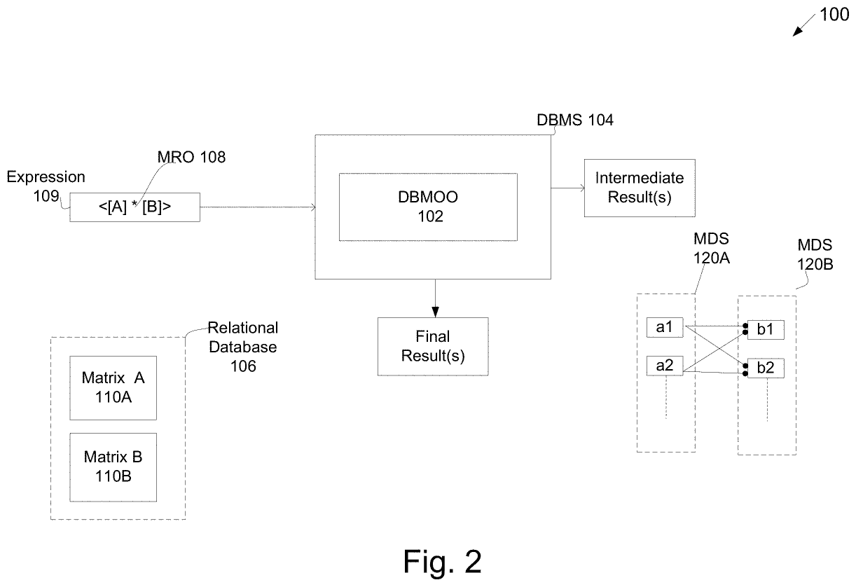

Embodiments of some aspects of the improved techniques are also discussed below with reference to FIGS. 2-12B. However, those skilled in the art will readily appreciate that the detailed description given herein with respect to these figures is for explanatory purposes as the invention extends beyond these limited embodiments.

FIG. 2 depicts a Database Matrix Operations Optimizer (DBMOO) 102 in a database computing environment 100 in accordance with one embodiment. As will be discussed in greater detail below, the Database Matrix Operations Optimizer (DBMOO) 102 can, among other things, effectively provide a more efficient way of performing Matrix-Related operations (e.g., Matrix Multiply operation, Matrix Transpose operation) in the database computing environment 100. The Matrix-Related operations are operations that can be performed on the data stored in a Relational Database 106 the database computing environment 100.

As suggested by FIG. 2, Database Matrix Operations Optimizer (DBMOO) 102 can, for example, be provided as, or at least as part, of Database Management System (DBMS) 104 for a relational database 106. As those skilled in the art will readily appreciate, the DBMS 104 can be provided (e.g., configured, adapted. programmed) to effectively manage the Relational Database 106. As such, the Database Matrix Operations Optimizer (DBMOO) 102 can include one or more processors at least configured to manage the Relational Database 106 by least storing and manipulating data therein. Generally, Database Matrix Operations Optimizer (DBMMO) 102 can be provided as hardware and/or software, or a combination of hardware and software components. Typically, it may be more practical and/or feasible to provide the Database Matrix Operations Optimizer (DBMOO) 102 as a part of Database Management System (DBMS) 104 so that, among other things, a more robust set of database optimization of database queries of the Relational Database 106 can be provided by the Database Management System (DBMS) 104 as will be discussed in greater detail below.

As noted above, the Database Matrix Operations Optimizer (DBMOO) 102 can, among other things, effectively provide a more efficient way of performing Matrix-Related operations (e.g., Matrix Multiply operation, Matrix Transpose Operation) in the database computing environment 100. Referring to FIG. 2, a Matrix-Related operation (MRO) 108 of an expression 109 can be a Matrix-Related operation between two matrices, namely Matrix A (110A) and Matrix B (110B). Matrix A (110A) and Matrix B (110B) can, for example, represent at least a part of Data A and Database Data B, respectively. Data A and Database Data B can be stored in various forms, for example, in one or more database tables in the Relational Database 106, as those skilled in the arty will readily appreciate.

In any case. the Database Matrix Operations Optimizer (DBMOO) 102 can obtain (e.g., receive, identify, determine, select) the Matrix A (110A) and Matrix B (110B) as input for its optimization operation.

As noted above, the Matrix A (110A) and Matrix B (110B) are related together in an expression 109 by a Matrix-Related operation (MRO) 108 that needs to be performed. As such, in addition to the Matrix A (110A) and Matrix B (110B), Matrix-Related operation (MRO) 108 can also be obtained (e.g., identified) by the Operations Optimizer (DBMOO) 102 Matrix-Related operation for optimization. In order to optimize the Matrix-Related operation (MRO) 108, the Operations Optimizer (DBMOO) 102 can determine (e.g., select, generate, identify) a first Matrix Data Set (MDS) (120A) and a second Matrix Data set (MDS) (120B) for the first and second input matrices, namely, Matrix A (110A) and Matrix B (110B). Each one of the first Matrix Data Set (120A) and a second Matrix Data set (120B) can be determined at least partly based on a partitioning of their respective data such that each one of the partitions (or members) of the determined data sets is a disjoint subset of the data. In other words, first Matrix Data Set (120A) can be determined at least partly based on a partitioning of its data such that each one of the partitions is a disjoint subset of the first Matrix Data Set (120A) and a second Matrix Data Set (120B) can be determined at least partly based on a partitioning of its data such that each one of the partitions is a disjoint subset of the second Matrix Data Set (120B).

In determining the first Matrix Data Set (120A) and a second Matrix Data Set (120B), the Operations Optimizer (DBMOO) 102 can consider physical properties of the Matrix A (110A) and Matrix B (110B) and/or processor(s) as will be described in greater detail below. By way of example, the size of one or more Caches of CPUs configured to calculate a Matrix Multiply operation can be considered. In the example, if the size of a cache is 64 Bytes and each one of the first Matrix Data Set (120A) and a second Matrix Data Set (120B) are 1000×1000 matrices with each entry (or cell) being 8 Bytes for Floating operations, then the first Matrix Data Set (120A) and a second Matrix Data Set (120B) can be determined as (or partitioned into blocks of) 8×8 cells. In other words, each member of the set of the first Matrix Data Set (120A) can be 8×8 (64) Bytes, and so on. As a result, each of the blocks of values from first Matrix Data Set (120A) and second Matrix Data Set (120B) can be stored in the CPU cache of the processor being considered and computed directly from the cache of the processor without having to copy input data as it will appreciated by those skilled in the art.

After the first Matrix Data Set (120A) and a second Matrix Data Set (120B) have been determined, at least one matrix-related operation, namely, MRO 108 can be performed at least between each one the members (a1, a2) of the first Matrix Data Set (120A) and one or more of the members (b1, b2) of the second Matrix Data Set (120B) to determine (e.g., calculate, lookup) one or more partial results 130. The calculations can, for example, be performed directly in one or CPU Caches in a manner described above. Thereafter, at least one output result 140 can be determined by the Operations Optimizer (DBMOO) 102 based on the one or more partial results 130. It should be noted that the output result 140 can be a result of the input Matrix-Related operation (MRO) 108 performed for the Matrix A (110A) and Matrix B (110B). Moreover, the output result 140 can be determined more efficiently by the Database Matrix Operations Optimizer (DBMOO) 102 than a result obtained by conventional techniques, as it will be described in greater detail below. In other words, the Database Matrix Operations Optimizer (DBMOO) 102 can optimize a database query of the Relational Database 106 by at least optimizing the performing (or calculation) of the Matrix-Related operation (MRO) 108 by using Matrix Data Sets that can be provided as disjointed subsets of the matrix data involved in the operation (e.g., Matrix Data Set (120A) and Matrix Data Set (120B)).

It will also be appreciated that the optimization of the Matrix-Related operation (MRO) 108 can be even more meaningful in a parallel computing environment where multiple processes can operate in parallel to effectively perform computations in parallel. By way of example, the operation associated with MRO 108 for each one the members (a1, a2) of the first Matrix Data Set (120A) and one or more of the members (b1, b2) of the second Matrix Data Set (120B) can be effectively distributed between multiple processors (not shown in FIG. 2) and performed in parallel (or at the same time). To vastly simplify, intermediate results can be calculated and distributed between multiple processors. The intermediate results can also be combined and distributed to the multiple processors as many times as needed before combining the partial result(s) to obtain the final result(s) (130). It should be noted that the final result (130) can be multiple results.

In one exemplary embodiment in multiprocessing computing system, the Database Matrix Operations Optimizer (DBMOO) 102 can be configured to distribute multiple members of the first Matrix Data Set 120A on each one of the multiple processors configured to collectively process multiple Matrix-Related operations in parallel. Next, Database Matrix Operations Optimizer (DBMOO) 102 can combine a set of per-input data set member pairs on each one of the multiple processors by at least using the Matrix-Related operation (MRO 108) to obtain a set of per-input data set member pair partial results on each one of the multiple processors configured to process the multiple matrix-related operations (MRO 108) in parallel. Then, the set of partial results obtained on each one of the multiple processors can be distributed between the multiple processors configured to process the multiple matrix-related operations in parallel and one or more partial results can be combined by at least using an additional matrix-related operation to obtain one or more final (or output) results.

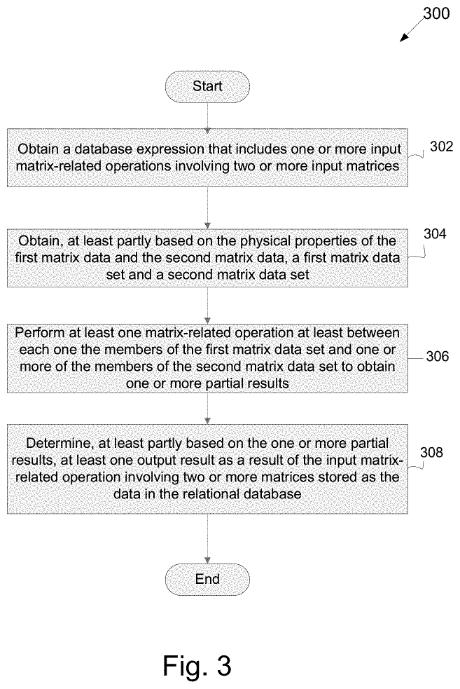

FIG. 3 depicts a method 300 of performing Matrix-Related operations associated with a Relational Database in accordance with one embodiment. It should be noted that Matrix-Related operations can, for example, be performed in and/or by a Relational Database Management System (RDBMS) that includes one or more processors at least configured to manage a relational database by least storing and manipulating data therein. As such, method 300 can, for example, be performed by the Database Matrix Operations Optimizer (DBMOO) 102 in a RDBMS 104 (shown in FIG. 2).

Referring to FIG. 3, initially, a database expression is obtained (302) as input. It should be noted that the database expression includes one or more matrix-related operations involving two or more input matrices stored as data in the relational database. The two or more input matrices include a first matrix data and a second matrix data stored in the relational database. Next, a first matrix data set and a second matrix data set are obtained (e.g., determined, identified, received) (304) for the input first matrix data and second matrix data. It should be noted that data sets can be determined at least partly based on the physical properties of the first matrix data and the second matrix data and/or processors. Also, the first matrix data set can be determined at least partly based on a partitioning of the first matrix data such that each one of the partitions of the first data set is a disjoint subset of the first matrix data. Similarly, the second matrix data set can be determined at least partly based on a partitioning of the second matrix data, such each one of the partitions of the second data set is a disjoint subset of the second matrix data. After the first and second data sets have been obtained (304) for the obtained (302) first and second matrices, at least one matrix-related operation can be performed (306) at least between each one the members of the first matrix data set and one or more of the members of the second matrix data set to obtain one or more partial results. Finally, at least one output (or Final) result is determined (308) at least partly based on the one or more partial results before the method 300 ends. It should be noted that least one output result represents a result of the input matrix-related operation(s) involving two or more input matrices. However, the output result can be obtained more efficiently than conventional techniques for performing matrix-related operations in a relational database. In other words, the matrix-related operations can be optimized by using method 300.

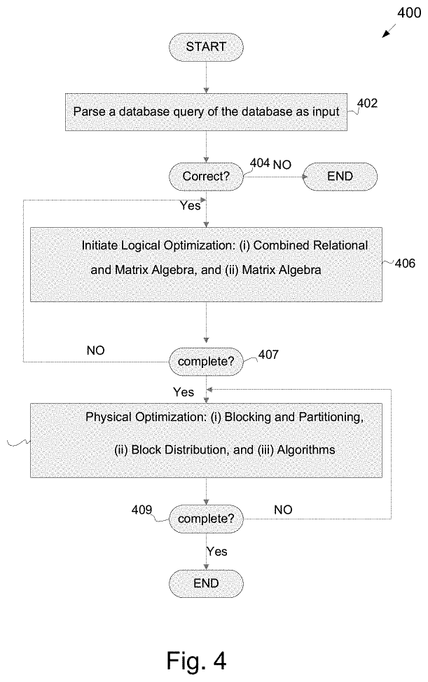

To further elaborate, FIG. 4 depicts a method 400 for optimizing a database query of a Relational Database in accordance with one embodiment. It should be noted that database query includes an expression involving at least one matrix-related operation between two or more matrices that are stored as data in the Relational Database. Method 400 can, for example, be performed by the Database Matrix Operations Optimizer (DBMOO) 102 (shown in FIG. 2) in a Relational Database Management System that includes one or more processors at least configured to manage a relational database by least storing and manipulating data therein.

Referring to FIG. 4, initially, a database query of a Relational Database is parsed (402). It should be noted that the input database query includes one or more input matrix-related operations involving two or more input matrices stored as data in the Relational Database. For example, the database query can be written in a declarative query language (e.g., SQL) as one or more declarative statements, including at least one database Multiplication-Related operation in a database query language as can be provided in accordance with one aspect of the improved techniques. The exemplary operations can include a Matrix Multiply operation and a Matrix Transpose operation.

Next, the correctness of the obtained (402) database query can be verified (404) and an error can be output if its correctness cannot be verified (404) before the method 40 ends. The Verification (404) of correction of the database query can, for example, include verifying the semantic validity of the declarative expression by at least: (i) determining whether one or more tables and columns of the database that are named by the database query of the database exist with appropriate types; and (ii) determining whether an expression associated with the database query of the database can be translated into a procedure consistent with an associated (underlying) input database schema, as will be appreciated by those skilled in the art. The Verification (404) of correctness of the database query can, for example, be performed by a Relational Database Management System in order to determine how to process or initiate the processing the database query by at least optimizing the Matrix Multiply operation(s) associated with the database query.

If the correctness of the obtained (402) database query can be verified (404) the method 400 can then proceed to initiate a first major phase of optimization, namely it can initiate (406) a Logical Optimization phase. Generally, in the Logical Optimization (406) one or more logical equivalent forms can be determined for the database query. As noted in FIG. 4, in the logical optimization phase (406) can include two (2) operational phases, namely: (a) Combined Relational and Matrix Algebra, and (b) Matrix Algebra.

To further elaborate with respect to “Combined Relational and Matrix Algebra,” it should be noted that certain properties of the extended algebra relate to how relational operators—projection, selection, join, union, etc.,—can be combined with the Matrix-related operators (e.g., Transpose and Multiply). For example, a restriction on the result of a multiply can be “pushed down” and applied to the inputs to the multiply with the potential to dramatically reduce the computation cost of the overall query. As such, one or more database relational operations (e.g., projection, selection, join, union, etc.) can be combined with one or more Matrix-Related operations, including, for example, Matrix Transpose operations and Matrix Multiply operations.

With respect to the second part of the Logical Optimization phase (406), namely “Matrix Algebra,” it should be noted that as exemplary operations, Matrix MULTIPLY and TRANSPOSE can be algebraic building blocks with properties of their own. Some of these rules are simple heuristics: TRANSPOSE*TRANSPOSE of a MATRIX is simply the original MATRIX. Others can involve constraints operations that can allow a query optimizer to select the order in which they happen. For example, A MULTIPLY B MULTIPLY C can be computed one of two ways, as (A×B)×C, or A×(B×C), and determining which is better is something a cost-based optimizer can be configured to perform. As such, for example, as a part of the second part of the Logical Optimization phase (406), namely “Matrix Algebra an order of performing two or more multiply related operations can be determined by at least considering Matrix Algebra in order to optimize the database query.

After the Logical Optimization phase (406) has completed, the method 400 can proceed to the second main phase of optimization, namely, a Physical Optimization phase (408). In other words, when it has been determined (404) that there is a semantically valid expression, an a logically optimal query plan for execution of the database has been determined (406), the next phase of optimization can include selecting low-level physical algorithms and data structures for carrying out the computation. This is another facet of query processing (or query optimizing) where a cost-based optimizer can be well placed to make informed decisions about the best choice of physical algorithms from among a number of alternatives.

As shown in FIG. 4, the Physical Optimization phase (408) can include three (3) parts: (i) Blocking and Partitioning (ii) Block Distribution and (iii) Algorithms. With respect to the first part of the Physical Optimization phase (408), namely, “Blocking and Partitioning,” it should be noted that the most efficient way to compute a matrix multiply result is to decompose the two input data sets into blocks or partitions, and then to combine blocks from each input in (a carefully organized) order so as to compute a block of output at a time. The choice of block size (physical) and block shape (square or rectangular) can be contingent on various factors, for example, including the size and shape of the input arrays (details the query processor will know) and contingent details about the physical computer architecture on which the calculation will be performed (how many CPUs/CPU-cores, size of per-CPU-core cache, DRAM memory size, storage access costs) as well as the nature of the input calculation (number of pairs of matrices being multiplied, per-input-matrix sizes and shapes, dense or sparse data).

With respect to the second part of the Physical Optimization phase (408), namely, “Block Distribution,” it should be noted that in the context of a distributed or massively parallel processing architecture providing a number of computers cooperatively computing the matrix multiply result, efficiency (and algorithmic correctness) can benefit from careful distribution of the input blocks among the several computers, and then the careful orchestration of inter-computer communication of intermediate result or input blocks.

With respect to the third part of the Physical Optimization phase (408), namely, “Algorithms,” it should be noted that at a level of a single computer calculation, it can be tremendously beneficial to choose from among several low-level physical algorithms depending on factors, for example, such as the shape of the input blocks, the degree of sparsity or density of the input data, and whether or not specialized hardware (GPUs) are available to the query processor, etc.

It will be appreciated that the operations performed during the Physical Optimization phase (408) can, for example, include performing Physical Optimization of the least one Matrix Multiply Related operation by at least determining how to process a logical query plan for processing the database query of the database. As another example, during the Physical Optimization phase (408) one or more (low level) physical algorithms can be selected for processing of the least one Matrix Multiply Related operation, and one or more data structures can be selected for processing the least one Matrix Multiply Related operation. As yet another example, provisioning ad/or reserving of one or more physical computing resources of the database management system can be performed during the Physical Optimization phase (408). The computer resources of the database management system can, for example, include one or more CPU time, memory, temporary storage space, and network bandwidth.

In addition, during the Physical Optimization phase (408), multiple data blocks can be distributed to multiple processors of the database management system for parallel processing by the multiple processors. The data blocks can represent the data sets determined based on partitioning a matrix as noted above. By way of example, all of data blocks of first and second input matrices can be distributed to a single processor of multiple processors of a database management system where a final result is to be computed. In addition, copies of all of the data blocks for the first input matrix can be created on all of the processors the database management system while distributing a subset of data blocks of the second input matrix to different processors of the multiple processors to compute a per-processor local result that is a portion of the final result before combining per-processor portions into the final result. Furthermore, a subset of the data blocks of a first input matrix can be distributed to each of the processors of the multiple processors while distributing a subset of data blocks for the second input to each processor to compute a per-processor local result before iteratively redistributing or moving blocks of both input matrices among the multiple processors until the complete set of block-wise partitions is calculated. Thereafter, the per-processor portions can be combined into one or more final results. It should be noted that the operations above can be repeated until one or more final results can be determined.

Although not shown in FIG. 4, optimization of a database query with respect to Matrix-Related operations can involve additional aspects. For example, in one aspect, data can be organized in a form that is better suited for optimization Matrix-related operations. To further elaborate, in the same way that data in a SQL DBMS can benefit from the addition of indices, row or columnar organization, or the repeated re-use of pre-calculated results, organizing matrix data in storage in a manner that lends itself to efficiently computing multiply is another area where a DBMS can be extended to improve the computation of matrix multiply results. For example, a table organized as an array might be stored on disk in a pre-blocked/pre-partitioned manner, the individual blocks might be organized as sparse or dense encodings. This is an area where an evaluation of the overall query workload is necessary for a Database Administrator or some automatic workload manager to suggest improvements. By way of example, data can be stored in a relational database in a manner that is pre-partitioned for processing of the matrix-related operation. Data can also be stored in accordance with one or more encodings such that data is stored in a space-efficient manner. As another example, data can be organized from input matrices into blocks suitable for calculations. Other aspect and embodiment are further discussed below with emphasis on Matrix Multiply as an example.

### Mathematical Properties of Matrix Multiply

Given the prevalence and importance of Matrix Multiply operation, this operation is discussed in greater detail with respect to another problem with the conventional ways SQL processes the Matrix Multiply query, namely the mathematical properties of Matrix Multiply itself.

As noted above, “Pairing, partitioning and aggregating” performed conventionally in Relational Databases can vastly increase the cost of the matrix multiply operations relative to how it is done on non-DBMS platforms. However, it will be appreciated that in accordance with one aspect of the improved techniques disclosed below, a better practice can be adapted by bringing blocks of values from A and B into the CPU cache and computing the corresponding block of C results directly, without copying input data.

A second problem with the way conventional systems processes Matrix Multiply in Relational Database queries has to do with the mathematical properties of Matrix Multiply itself. In other words, conventional SQL optimizers decompose queries into set theoretic operators, and then seek to find efficiencies by reordering how pairs of adjacent operators are scheduled. Yet it is possible to optimize queries with Matrix Multiply operations in ways that are impossible when the optimization strategy is limited to just re-ordering a pipeline of set theoretic steps. For instance, when considering the compound operation: A×B×C, it is possible to compute this either as (A×B)×C, or A×(B×C). Depending on the shapes of the matrices A, B and C one of these orderings may be vastly more computationally efficient than the other. Further, it is not possible to take A×B×C and logically re-order the operations into (say) A×C×B, as matrix multiply (unlike all relational operators) is not commutative. Consequently, in order to be more practical, it is highly desirable and beneficial to effectively “teach” the SQL optimizer rules about how it can manipulate query expressions that include matrix multiplication at a logical level.

As such, it will be appreciated that a Matrix Multiplication operation can be introduced such that it can be directly invoked within a database query in accordance with one aspect. From a SQL syntax perspective, Matrix Multiplication can be added as an operation that can be directly invoked within a query, in much the same way various flavors of OUTER JOIN were added to SQL in 1992, 10 years after SQL was first adopted and 6 years after the first standard was published.

The following proposed syntax is logically equivalent to the pure SQL query introduced above. Because of this equivalence it is reasonable to characterize the matrix multiply syntax proposal as “sugar”. That is, nothing that can be expressed using this proposed syntax cannot also be expressed in conventional SQL. But by making the MULTIPLY explicit, it becomes possible to deploy a range of query optimizations, algorithms, and data structures:

SELECT A.R AS R,

B.C AS C,
SUM ( A.V * B.V ) AS V

FROM A MULTIPLY B ON ( A.C = B.R );

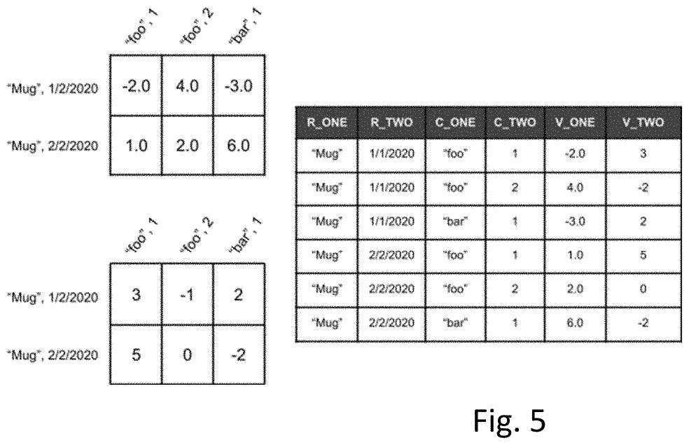

Because SQL tables can have compound keys, the innovative syntax can support compound columns as dimension indices, as well as the ability to calculate multiple per-output-cell results as shown in FIG. 5 in accordance with one embodiment.

Then, a database query that multiplies the two matrices in A with another two matrices in another table we will call B—one matrix for each of the V_ONE and V_TWO value columns—would look like this:

SELECT A.R_ONE AS R_ONE,

A.R_TWO AS R_TWO
B.C_ONE AS C_ONE,
B.C_TWO AS C_TWO
SUM ( A.V_ONE * B.V_ONE ) AS V_ONE,
SUM ( A.V_TWO * B.V_TWO ) AS V_TWO

FROM A MULTIPLY B ON

( A.C_ONE = B.R_ONE AND A.C_TWO = B.R_TWO

)

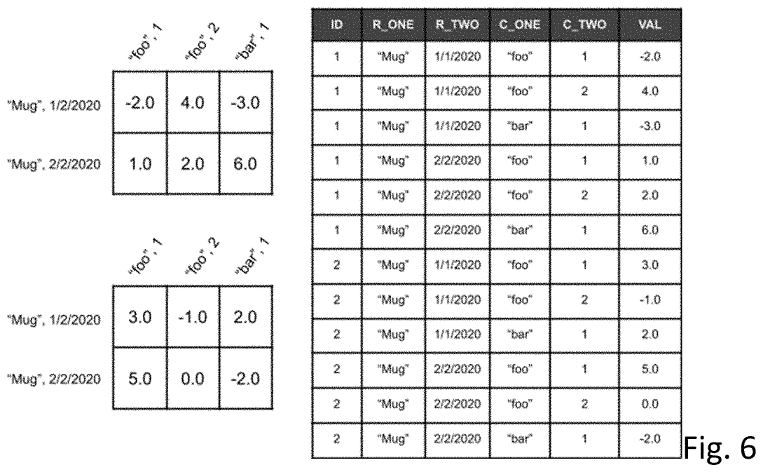

This innovative syntax can also support matrix multiplication over two input sets of matrices. The idea here is that a SQL table with only one “value” column can nevertheless still hold multiple distinct matrices, each of which is distinguished from the others by the value in some kind of “ID” column as depicted in FIG. 6 in accordance with one embodiment. Referring to FIG. 6, the table form—to the right—contains both of the arrays introduced to the left. A column in the table “ID” contains values that let us differentiate between them.

When there are two tables of this kind, each with two matrices, then we need to provide syntax to support an operation that produces as output “each matrix in one table multiplied by each matrix in the second”. That is, if Table T₁ includes matrices A₁ and A₂, and Table T₂ includes matrices B₁ and B₂, we want to be able to produce a table T₃ with A₁×B₁, A₁×B₂, A₂×B₁ and A₂×B₂. From a mathematical point of view this only requires that we extend the definition of each input matrix's dimensions with the ID column:

SELECT A.ID AS A_ID,

B.ID AS B_ID,
A.R_ONE AS R_ONE,
A.R_TWO AS R_TWO
B.C_ONE AS C_ONE,
B.C_TWO AS C_TWO
SUM ( A.V_ONE * B.V_ONE ) AS V_ONE,
SUM ( A.V_TWO * B.V_TWO ) AS V_TWO

FROM A MULTIPLY B ON

( A.C_ONE = B.R_ONE AND A.C_TWO = B. R_TWO ) ;

Another important function that the innovative syntax can supports is the ability to transpose one of the matrices being multiplied in accordance with embodiment. The transpose of a matrix is an operator which flips a matrix over its diagonal; that is, it switches the row and column indices of a matrix—say, A—into a new matrix—usually indicated as A^{T}. Multiplying a matrix by its own transpose is a relatively common thing to do as the resulting matrix has a basic measure of the distance between each “row” of the input and every other “row”. The syntax for A×A^{T} looks like this:

SELECT A1.R AS R,

A2.R AS C,
SUM ( A1.V * A2.V ) AS V

FROM A AS A1 MULTIPLY A AS A2 ON ( A1.C = A2.C );

The innovative syntax can support a wide variety of flavors of matrix multiplication. One implementation would be simply to translate the innovative MULTIPLY syntax into the equivalent SQL SUM-JOIN-GROUP_BY query of the kind used to describe what matrix multiply does. However, for reasons touched on above, this is unlikely to result in very efficient execution of the query. First, the best low-level algorithms used to calculate the matrix multiply result don't look at all like the algorithms used to compute the separate JOIN and then GROUP_BY operations. Second, there are optimization opportunities that the SQL DBMS can exploit by treating the matrix multiply as a singular operator; a peer with the other set theoretic operators of the relational/SQL algebra.

It is more desirable to provide a syntax to support multiplying many matrices where each matrix's ID is a combination of columns:

SELECT A.ID_1 AS A_ID_1,

| | |
|---|---|
| A.ID_2 | AS A_ID_2, |
| B.ID_1 | AS B_ID_1, |
| B.ID_2 | AS B_ID_2, |
| A.R_ONE | AS R_ONE, |
| A.R_TWO | AS R_TWO |
| B.C_ONE | AS C_ONE, |
| B.C_TWO | AS C_TWO |

SUM ( A.V_ONE * B.V_ONE ) AS V_ONE,
SUM ( A.V_TWO * B.V_TWO ) AS V_TWO

FROM A MULTIPLY B ON

( A.C_ONE = B.R_ONE AND A.C_TWO = B.R_TWO

BY A.ID_1, A.ID_2 AND B.ID_1, B.ID_2

) ;

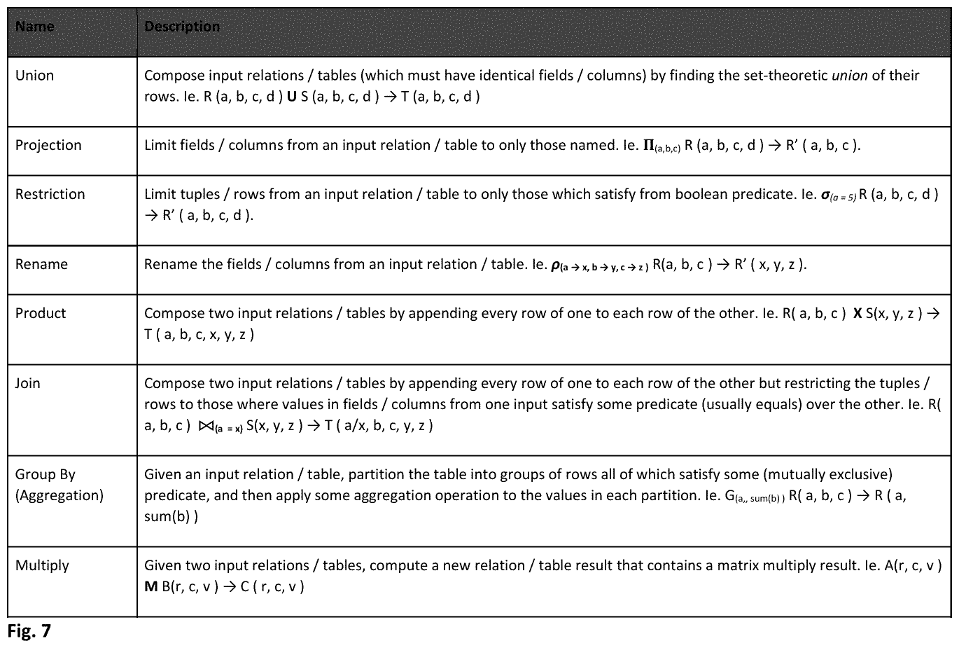

To further explore additional optimization opportunities, it's useful, at this point, to introduce some notation. FIG. 7 depicts a table that lists a number of Basic Relational operators in accordance with one embodiment. It should be noted that in the table shown in FIG. 7 Greek Mu (M) is used to denote Matrix Multiply.

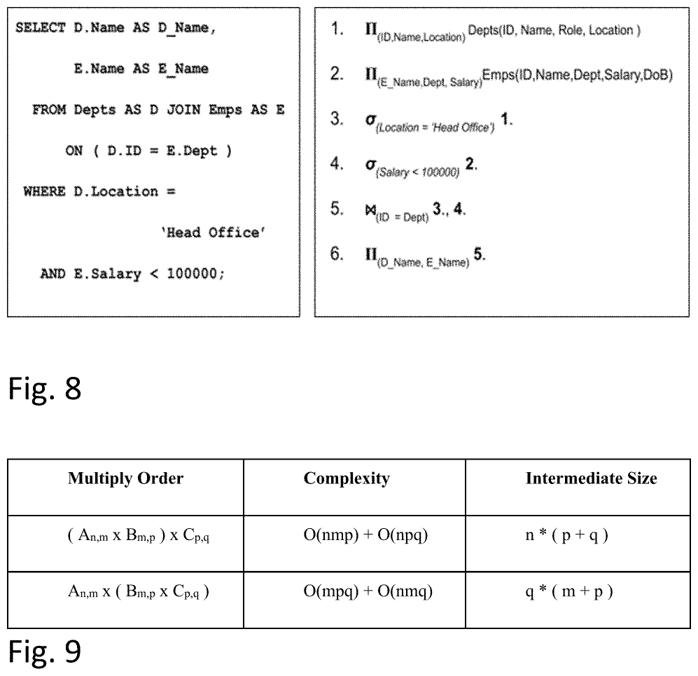

It should also be noted that SQL queries can be compiled into a sequence of these operators, with the output of one forming the input of the next. FIG. 8 illustrates what a sequence of these operators corresponding to a fairly simple query might look like in accordance with one embodiment.

One key idea in query optimization is that these operations can be re-ordered into logically equivalent but more (or less) efficient sequences. For example, swapping the order of the Projection and Restriction steps might reduce the amount of data being passed between the first two steps, and this swapping is possible because the Projection operator is commutable with Restriction. Including Multiply as its own operator alongside the well-known relational operators creates a number of opportunities for similar logical re-writes. A number of these opportunities are listed below.

### Associative Property of Multiply

As with relational/set-theoretic operators such as join, it's possible to combine a series of matrix multiply operations in a single query. For instance, A×A^{T}×B. Now, unlike joins, matrix multiply operations are not commutable. That is, while A [symbol] B=B [symbol] A, A×A^{T}≠A^{T}×A, and this complicates the procedure how the “space of possible alternative logical plans” is defined. However, matrix multiply (and join) is associative. That is, A×A^{T}×B=(A×A^{T})×B=A×(A^{T}×B), which means you can do the first multiply and then take it's result and multiply by the last matrix, or you can do the second multiply and then multiply the first matrix by that result. And depending on the shape—the number of rows and columns—in each of the input arrays, these logically equivalent sequences of operations can have very different computational costs.

Consider: A_{n,m}×B_{m,p}×C_{p,q}→R_{n,q}. As the computational complexity of a matrix multiply involving two matrices A_{n,m} and B_{m,p} is O(nmp) and produces an output matrix with size O_{n,p}, the computational complexity intermediate storage space required by each can be determined as shown in FIG. 9. Clearly, ordering the matrix multiply operations makes significant differences in the cost of these calculations.

### Lack of Commutability for Multiply

The matrix multiply operation is not commutative. This has the effect of constraining the space of valid re-organizations of the plan, and suggests that only query optimizers that can generate so-called “bushy” plans (as opposed to left or right deep “linear” plans) can be adapted to exploit the Associative property of matrix multiplication.

### Commutativity of Multiply With Respect to Projection, Rename

Operations such as Projection and Rename can be moved “down” the plan tree in a manner consistent with other relational operators.

### Interaction With Restriction

The interaction between Restriction and Matrix Multiply is more complex. Consider the following query:

WITH Data AS (
SELECT A1.R AS R,

```
  A2.R AS C,
  SUM ( A1.V * A2.V ) AS V
```

FROM A AS A1 MULTIPLY A AS A2

ON ( A1.C = A2.C )

```
)
SELECT *
  FROM Data AS D
  WHERE D.R < 100;
```

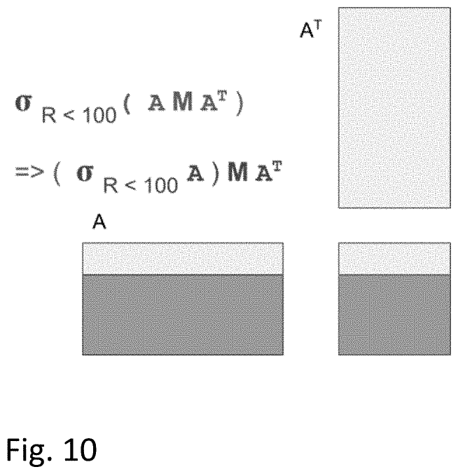

Without more sophisticated optimization, the naive way to compute this result would be first, to compute the complete matrix multiply, and then to filter out only those rows that are wanted. But the row filter can be pushed through the Matrix Multiply to limit the size of the computation required as depicted in FIG. 10 in accordance with one embodiment.

However, a restriction based on the output cell values cannot be pushed through the multiply operation. For example, there is no way to push the D.V<100.0 restriction in this query's WHERE clause to a point in the plan prior to the Matrix Multiply operation.

WITH Data AS (
SELECT A1.R AS R,

```
  A2.R AS C,
  SUM ( A1.V * A2.V ) AS V
```

FROM A AS A1 MULTIPLY A AS A2

ON ( A1.C = A2.C )

```
)
SELECT *
  FROM Data AS D
  WHERE D.V < 100.0;
```

### Matrix Multiplication Equivalences

It's worth noting at this point that the list of rules for logical reorganization of a query plan above is far from complete.

### More Detailed Level Exemplary Implementation

With respect to a more detailed level of the implementation, let's turn our attention to the data structures and algorithms used in the core of the Matrix Multiply operation. It's important that we begin this discussion by highlighting a number of principles that will guide low-level software engineering.

First, there is the way, at the most fine-grained level, the key to performance on modern CPUs is to optimize data and execution instructions caches on the CPU so as to minimize DRAM to CPU cache bandwidth consumption. That is, we want to load data and instruction from DRAM to CPU cache, do as much with that data as we possibly can, and then push the result back to DRAM. Optimization at this most granular level of detail involves the use of specialist libraries created by CPU manufacturers and relies on organizing the data being multiplied in quite specific ways. All production implementations of Matrix Multiply rely on such libraries for efficiency.

Second, performing a calculation like Matrix Multiply at scale usually involves distributing the overall operation over a (possibly large) number of computers; in other words, best practice is to adopt a distributed approach. The input data is partitioned into small (generally a few KB) blocks, the blocks are arranged over the distributed computers each of which performs some local calculations (in parallel). Then the blocks are shuffled repeatedly between the distributed computers until the overall result is produced, with different partitions of the result located on each of the participating computers. Parallel and distributed approaches to matrix multiply are well studied, and there are a number of widely used tools that implement the approach.

Finally, an approach to implementing matrix multiplication should keep in mind the variability in the nature of what the query is being asked to compute. Matrix data varies in how much data is involved, the shape of the inputs, and whether the matrix data is dense (meaning every logical cell has a value, common in statistical analysis or signal processing) or sparse (meaning the matrix data contains many cells with zero value, common in graph processing). From the syntax of the queries introduced above, it is impossible to tell anything about the nature of the calculations involved. Depending on the input data, the underlying calculation might most efficiently be done one of several ways. Consequently, in common with SQL functions such as JOIN and UNION, supporting Matrix Multiplication will require implementing several algorithms and allowing the optimizer to choose between them based on the properties of the input data.

### Dense Matrix Data Handling and Sparse Matrix Data

To maximize the use of limited DRAM->CPU bandwidth, the specialist libraries implementing matrix multiplication and provided by hardware vendors or the open-source community break input matrices into blocks, where each block has some fixed upper bound in its physical size, and each block covers some logically equal portion of the matrix. The physical size of a block is determined by the characteristics of the CPU cache (or the GPU's properties) and some measure of the concurrency, ie., the number of matrix operations being simultaneously computed.

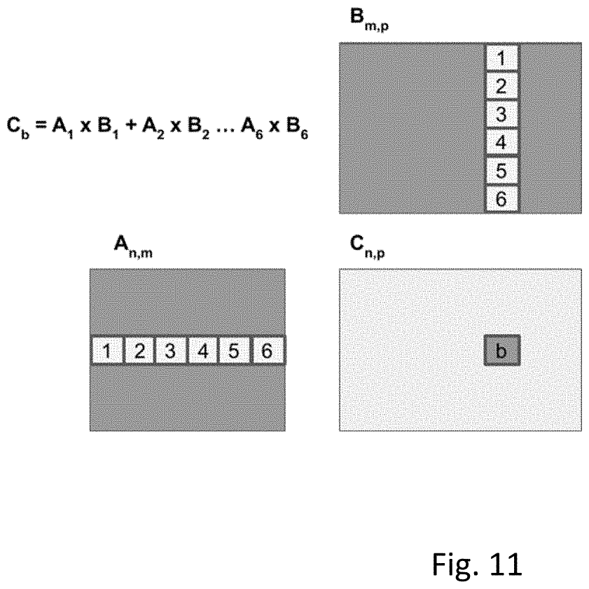

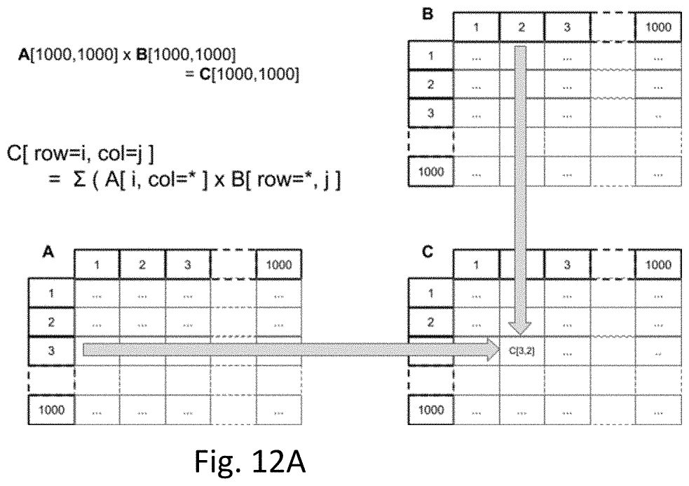

Typically, a block size can be about 256 bytes holding 64 double precision (8 byte) values. Thus, if the input matrix A_{1024,1024} is dense, this means we can break it up into 128×128 blocks, where each block has 8×8 double precision values. When we're multiplying two matrices A_{1024,1024}×B_{1024,1024}, we break each onto 128×128 blocks and then processing them by combining each block of A with each block of B that must be combined to compute the result as shown in FIG. 11.

Computing C_{b} while minimizing the amount of data moved between DRAM and CPU cache means loading A₁, then loading B₁ through B₆ (in no particular order) to compute the set of values for C_{b} before moving on to A₂ and only writing C_{b} out to DRAM once it is computed in its entirety. Those skilled in art of DBMS will appreciate that this approach can be applied recursively. Although the blocks we have talked about so far are designed to minimize DRAM and CPU bandwidth, the same principle applied to larger blocks and to the relationship between DRAM and external storage.

For sparse matrices it is also considered best practice to adopt the same kind of block-wise decomposition approach as for dense matrices. The difference is that additional space savings are possible by eschewing the regular array and instead of using an alternative form of encoding that omits all of the zero (or otherwise missing) values; for example, Compressed Row/Column or Yale format. From the perspective of DRAM and CPU bandwidth the idea again is to minimize the number of bytes moved about, and at the same time preserving the recursive decomposition of the overall input array into blocks appropriate for I/O and then smaller blocks appropriate for DRAM/CPU memory.

So, the high-level approach to parallelizing matrix multiply is to partition the input matrices into blocks of various sizes—rather than, say, serializing the entire matrix into row or column major order, or using some kind of space filling curve order—and then to apply inner-loop algorithms block-at-a-time so as to minimize memory, network and storage bandwidth. The details of how blocks are organized internally will vary depending on how sparse or dense the matrix data is.

Although it might be intuitively satisfying to do so, there's no need for two matrices to have their data organized in such a way that the indices are ordered. That is, it's not necessary, for the correctness of an operation like Matrix Multiply, that the value at A_{i,j} be “close” to the value A_{i+1,j} or A_{i,j+1}. All that is required for the algorithm to be correct is for the values in A_{i,j} and B_{j,i} to be organized in a manner consistent with the requirements of the block-wise calculations. That is, a block of A might have values from the 8 columns (just picking values to make the example concrete) with column indices, 837, 502, 501, 91, 710, 974, 661, and 293, so long as it is possible to identify the set of blocks of B which have the row indices 837, 502, 501, 91, 710, 974, 661, 293.

The idea is to allocate cells to “blocks” or “buckets” in such a way that we can pair up input blocks to compute a partial result and then add them up to a final result. Key thing is not needing to order the input matrix's indices (that is, try to avoid sorting them) to arrive at a useful bucketing. Within each block data can be arranged using the dense (or sparse) representation.

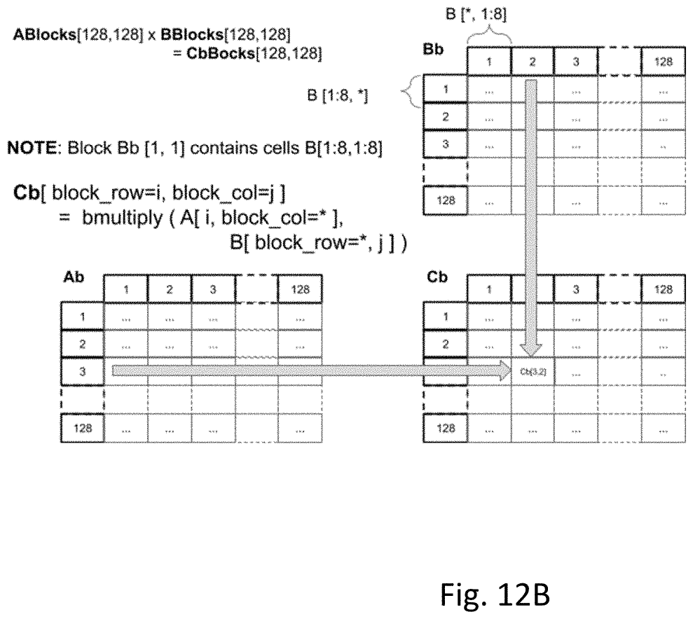

Given the design of modern CPUs and GPUs, the most efficient way to compute an A×B result is to decompose the input data into blocks or partitions of equal physical size and with the shape of the blocks chosen so that it's possible to compute one portion of a single block of output from just the input blocks, as depicted in FIG. 12A in accordance with one embodiment. First, we present the overall multiply calculation for a matrix that is has 1000 rows and 1000 columns. If each cell of this input is an 8-Byte double precision value, then each input has 8 MB and the result adds another 8 MB making for a total of 240 MB of data. As L1 cache sizes are usually of an order of 256 KB of data, and L2 and L3 caches are of a few MB to 10s of MB, such an operation would clearly benefit, from a DRAM<->CPU cache throughput perspective, from being broken up into smaller calculations.

In the example noted above, an important consideration is what would be a good physical size for matrix blocks so as to optimize for DRAM<->CPU cache efficiency. As CPU caches are very constrained, and as the “cache line” sizes-the amount of memory moved between CPU caches-is usually 64 Bytes, it benefits the system to have block sizes that are multiples of that. So, it is likely that a logical size for each block might be 8 cells×8 cells as a good estimate, which will result in the A, B and C matrices being broken into 128 blocks×128 blocks, with each block being 265 Byte in size as depicted in FIG. 12B in accordance with one embodiment.

As those skilled in the art will readily appreciate, distributed parallel calculations are very important for modern computing. As another example, start with a set of time series data; quickly changing prices of 100,000 assets, for example, over the previous 5 days at 8 hours trading a day with the prices recorded at about 1 second intervals. This is an array of 100,000×(5×8×2500 trades per hour)×4-Byte floats=>100,000×100,000×4=>40,000,000,000 or 40 GB of data. The result is an array 100,000×100,000×4 bytes=>40,000,000,000=>40 GB. As the computational complexity of the Matrix Multiply operation is O(n³) (where n is the length of one of the input Matrix sides) yielding about O(100,000³) or 10¹⁵ floating point operations. As a modern CPU can push through 4×3 GHz˜=10,000,000,000 (or −10⁹) floating point ops per second, calculating the all-pairs covariance result would take 10⁶ seconds, or approximately ten (10) days. As financial sector firms compete in large part on the timeliness of these calculations, they would prefer to have the result calculated daily, in enough time to change their buying and selling goals for next day's trade; say, 2 hours, or 1/10th of a day. Accomplishing this will require speeding up the calculation by 100×, which means combining the power of about 100 computers in this example.

Those skilled in the art will also readily appreciate that data partitioning and replications can be of substantial importance. As yet another example, again, consider the financial sector, but focus on calculations that a firm makes concerning the value of a particular trade. Simplifying greatly, this means multiplying a “portfolio” matrix (or a set of potential portfolios organized into a matrix) that is say, 10 portfolios each with some quantity of 100,000 assets (10×100,000) mixes by a vector of 100,000 asset prices (100,000×1) to yield a value for each of the 10 possible portfolios (10×1). This is (4 bytes×10 rows×100,000 columns=4 MB)×(4 Bytes×100,000×1=400 KB) yielding (4 bytes×10×1=40 Bytes) in result. Using the same procedure as above, it follows that this is has a computational complexity of O(10×100,000×1)=>1,000,000 or 10⁶ floating point operations, which can be completed in about 10⁻³ seconds, or 1 milli-second. Which is a good thing, given that automatic trading systems are likely to perform this calculation many times per second, and there are also likely to be many concurrently running trading applications. Clearly, this particular operation would not benefit by being distributed over a number of computers. In fact, the cost of inter-node communication in this case is likely to swamp the actual compute times. Further, this kind of operation would benefit by an approach to physical data organization that replicates commonly used data sets—such as the price vector—on each compute node, while at the same time distributing the (many) portfolios one per node.

Other considerations that will be appreciated by those skilled in the art, include, for example, include Low Level Efficiencies in Block-Wise Operations. Referring again to the example above that focus on calculations that a firm makes concerning the value of a particular trade, the data sizes for these inputs are 4 MB and 400 KB, yielding a tiny (40 Byte) result. An important consideration, in modern CPUs, has to do with the relationship between DRAM and CPU cache, and the most efficient computational methods involve decomposing inputs into blocks of data values and then performing the low-level calculations over pairs of blocks, rather than iterating over each input and performing the calculation value-at-a-time. As CPU caches are very size constrained, and as the “cache line” sizes—the amount of memory moved between CPU caches-is usually 64 Bytes, it benefits the system to have block sizes that are multiples of that. So a likely logical size for each block might be 8 cells×8 cells, which will result in the First input matrix to be broken into blocks of 4 (assets)×8 (per-portfolio allocations)×4 (Bytes)=128 Bytes while the Second might benefit from being partitioned into 32 (per-asset prices)×4 bytes=128 Bytes, with the overall calculation being handled by reading a block of the Second matrix into cache, then reading a series of blocks from the First matrix, and performing a per-block-pair calculation on each step. As this analysis suggests, there are considerable efficiency gains to be had by organizing data at a low level of granularity.

Conventional “Matrix multiplication algorithms” are generally known in the art and substantive on-going efforts are being made to make them even more efficient: “Because matrix multiplication is such a central operation in many numerical algorithms, much work has been invested in making matrix multiplication algorithms efficient. Applications of matrix multiplication in computational problems are found in many fields including scientific computing and pattern recognition and in seemingly unrelated problems such as counting the paths through a graph Many different algorithms have been designed for multiplying matrices on different types of hardware, including parallel and distributed systems, where the computational work is spread over multiple processors” (see, for example, “https:en.wikipedia.org/wiki/Matrix_multiplication_algorithm”).

The various aspects, features, embodiments or implementations described above can be used alone or in various combinations. For example, implementations of the subject matter and the functional operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter affecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CDROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, tactile or near-tactile input.

Implementations of the subject matter described in this specification can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described is this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

The various aspects, features, embodiments or implementations of the invention described above can be used alone or in various combinations. The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A computer-implemented method of performing matrix-related operations in a relational database management system that includes one or more processors at least configured to manage a relational database by least storing and manipulating data therein, wherein the computer-implemented method comprises:
obtaining, by the database management system, a database expression that includes one or more input matrix-related operations involving two or more input matrices stored as data in the relational database, wherein the two or more input matrices include a first matrix data and a second matrix data;
obtaining, by the database management system, at least partly based on the one or more physical properties of the first matrix data and the second matrix data and/or the one or more processors, a first matrix data set and a second matrix data set, wherein the first matrix data set is determined at least partly based on a partitioning of the first matrix data such that each one of the partitions of the first data set is a disjoint subset of the first matrix data, wherein the second matrix data set is determined at least partly based on a partitioning of the second matrix data, such each one of the partitions of the second data set is a disjoint subset of the second matrix data;
performing at least one matrix-related operation at least between each one the members of the first matrix data set and one or more of the members of the second matrix data set to obtain one or more partial results; and
determining, by the database management system, at least partly based on the one or more partial results, at least one output result as a result of the matrix-related operations involving two or more input matrices.

2. The computer-implemented method of 1, wherein the computer-implemented method of 1 further comprises:
optimizing the database query of the database by at least optimizing the performing of the one or more input matrix-related operations by at least the determining of the first matrix data set and the second matrix data set.

3. The computer-implemented method of 1,
wherein the relational database management system that includes multiple processors at least configured to operate in parallel; and
wherein the performing of the at least one matrix-related operation at least between each one the members of the first matrix data set and one or more of the members of the second matrix data set to obtain one or more partial results further comprises:
distributing, at least multiple matrix-related operations between the each one the members of the first matrix data set and one or more of the members of the second matrix data set, between the multiple processors configured at least to process the multiple matrix-related operations in parallel.

4. The computer-implemented method of 3, wherein the computer-implemented method of 2 further comprises:
(a) distributing multiple members of the first matric data sets on each one of the multiple processors configured to process the multiple matrix-related operations in parallel;
(b) combining a set of per-input data set member pairs on each one of the multiple processors by at least using a matrix-related operation to obtain a set of per-input data set member pair partial results on each one of the on each one of the multiple processors configured to process the multiple matrix-related operations in parallel;
(c) distributing the set of partial results obtained on each one of the multiple processors between the multiple processors configured to process the multiple matrix-related operations in parallel; and
(d) combining one or more partial results by at least using an additional matrix-related operation to obtain a final result.

5. The computer-implemented method of 4, repeating one or more operations of distributing (a), combining (b), distributing (c) and combining (d) as recited in claim 3.

6. The computer-implemented method of 1, wherein the matrix-related operation includes a matrix Multiplication Related operation that includes one or more of the following: a Matrix Multiply operation, and a Matrix Transpose operation.

7. The computer-implemented method of 1, wherein the computer-implemented method further comprises:
parsing a database query of the database as input, wherein the input database query includes the one or more input matrix-related operations involving two or more input matrices stored as data in the relational database.

8. The computer-implemented method of 7,
wherein the database query is stated as at least one declarative statement in a database query language, and
wherein the least one declarative statement includes at least one of the following provided as a database Multiplication-related operation for the database query language: a Matrix Multiply operation and a Matrix Transpose operation.

9. The computer-implemented method of 7, wherein the computer-implemented method further comprises:
verifying the correctness of the database query of the database that includes at least one matrix multiplication of the two or more matrices.

10. The computer-implemented method of 9, wherein the verifying of the database query of the database further comprises:
verifying the semantic validity of the declarative expression by at least:
determining whether one or more tables and columns of the database that are named by the database query of the database exist with appropriate types;
determining whether an expression associated with the database query of the database can be translated into a procedure consistent with an associated input database schema.

11. The computer-implemented method of 1, wherein the verifying of the database query of the database further comprises:
obtaining a database query by the database management system for processing by the database management system, wherein the database query requires at least one Matrix Multiply-Related operation involving at least the two or more matrices as input data from the data stored in the relational database;
determining by the database management system how to process the database query by at least optimizing the least one Matrix Multiply operation.

12. The computer-implemented method of 11, wherein the optimizing the least one Matrix Multiply operation further comprises:
Logical Optimization of the least one Matrix Multiply operation by at least determining one or more logical equivalent forms of at least a portion of the database query.

13. The computer-implemented method of 12, wherein the logical optimization further comprises:
combining one or more database relational operations (projection, selection, join, union, etc.) with one or more Matrix-Related operations including one or more of the following: a Matrix Transpose, a Matrix Multiply operation.

14. The computer-implemented method of 13, wherein the logical optimization further comprises:
determining an order of performing two or more multiply related operations by at least considering Matrix Algebra.

15. The computer-implemented method of 11, wherein the optimizing the least one Matrix Multiply-Related operation further comprises:
performing Physical Optimization of the least one Matrix Multiply Related operation by at least determining how to process a logical query plan for processing the database query of the database.

16. The computer-implemented method of 15, wherein the performing of the Physical Optimization comprises one or more of the following:
selecting one or more (low level) physical algorithms for processing of the least one Matrix Multiply Related operation; and
selecting one or more data structures for processing the least one Matrix Multiply Related operation.

17. The computer-implemented method of 15, wherein the performing of the Physical Optimization comprises one or more of the following:
provisioning or reserving one or more physical compute resources of the database management system,
wherein the one or more physical compute resources of the database management system include: CPU time, memory, temporary storage space, and network bandwidth.

18. The computer-implemented method of 15, wherein the performing of the Physical Optimization comprises one or more of the following:
blocking and partitioning of first data of at least the first matrix by at least: (i) determining one or more block sizes for the first data, and (ii) partitioning of the first data into data blocks according to the determined block size.

19. The computer-implemented method of 15, wherein the performing of the Physical Optimization further comprises:
distributing the data blocks to multiple processors of the database management system for parallel processing by the multiple processors.

20. The computer-implemented method of 15, wherein the performing of the Physical Optimization further comprises:
selecting one or more low-algorithms for performing a single computer calculation.

21. The computer-implemented method of 20, wherein the performing of the Physical Optimization further comprises:
distributing all of data blocks of the first and second input matrices to a single processor of multiple processors of the database management system where a final result is to be computed;
creating copies of all of the data blocks for the first input matrix on all of the processors the database management system while distributing a subset of data blocks of the second input matrix to different processors of the multiple processors to compute a per-processor local result that is a portion of the final result before combining per-processor portions into the final result; and
distributing a subset of the data blocks of a first input matrix to each of the processors of the multiple processors while distributing a subset of data blocks for the second input to each processor to compute a per-processor local result before iteratively redistributing or moving blocks of both input matrices among the multiple processors until the complete set of block-wise partitions is calculated, and
thereafter combining the per-processor portions into one or more final results.

22. The computer-implemented method of 1, wherein the computer-implemented method further comprises:
storing the data of the two or more matrices in the relational database in a pre-processed form that is configured for performing the matrix-related operation.

23. The computer-implemented method of 15, wherein the storing of the data of the two or more matrices in the relational database in a pre-processed form that is configured for performing the matrix-related operation further comprises:
storing data in a manner in a pre-partitioned for processing of the matrix-related operation; and
storing data of at least the first matrix data in accordance with one or more encodings (storing data in a space-efficient manner”, or “organizing data from input matrices into blocks suitable for calculations)

24. The computer-implemented method of 1, wherein the determining of first matrix data set and the second matrix data set is determined at least partly based on one or more sizes of one more cache memory of the one or more processors.

25. A computing device, comprising:
one or more processors configured to:
obtain a database expression that includes one or more input matrix-related operations involving two or more input matrices stored as data in the relational database, wherein the two or more input matrices include a first matrix data and a second matrix data;
obtain, at least partly based on the one or more physical properties of the first matrix data and the second matrix data and/or the one or more processors, a first matrix data set and a second matrix data set, wherein the first matrix data set is determined at least partly based on a partitioning of the first matrix data such that each one of the partitions of the first data set is a disjoint subset of the first matrix data, wherein the second matrix data set is determined at least partly based on a partitioning of the second matrix data, such each one of the partitions of the second data set is a disjoint subset of the second matrix data;
perform at least one matrix-related operation at least between each one the members of the first matrix data set and one or more of the members of the second matrix data set to obtain one or more partial results; and
determining, at least partly based on the one or more partial results, at least one output result as a result of the matrix-related operations involving two or more input matrices.

26. A non-transitory storage medium storing at least computer executable code for performing matrix-related operations in a relational database, wherein the computer executable code when executed:
obtains an expression that includes one or more input matrix-related operations involving two or more input matrices stored as data in the relational database, wherein the two or more input matrices include a first matrix data and a second matrix data;
obtains, at least partly based on the one or more physical properties of the first matrix data and the second matrix data and/or the one or more processors, a first matrix data set and a second matrix data set, wherein the first matrix data set is determined at least partly based on a partitioning of the first matrix data such that each one of the partitions of the first data set is a disjoint subset of the first matrix data, wherein the second matrix data set is determined at least partly based on a partitioning of the second matrix data, such each one of the partitions of the second data set is a disjoint subset of the second matrix data;
performs at least one matrix-related operation at least between each one the members of the first matrix data set and one or more of the members of the second matrix data set to obtain one or more partial results; and
determines, at least partly based on the one or more partial results, at least one output result as a result of the matrix-related operations involving two or more input matrices.
